(19) United States
(12) Patent Application Publication
(10) Pub. No.: US 2015/0009158 A1
(43) Pub. Date: Jan. 8, 2015

(54) ACTIVE SOLID-STATE TOUCH DISPLAY

(71) Applicant: HON HAI PRECISION INDUSTRY CO., LTD., New Taipei (TW)

(72) Inventor: JIAN-SHIHN TSANG, Tu-Cheng (TW)

(73) Assignee: HON HAI PRECISION INDUSTRY CO., LTD., New Taipei (TW)

(21) Appl. No.: 14/221,211

(22) Filed: Mar. 20, 2014

(30) Foreign Application Priority Data
Jul. 5, 2013 (TW) 102124238

(51) Int. Cl. G06F 3/041

(52) U.S. Cl. CPC G06F 3/041
USPC 345/173

(57) ABSTRACT

An exemplary light emitting touch display includes a nitride light emitting diode, a thin film transistor, and a touch unit. The nitride light emitting diode is formed on a first substrate. The thin film transistor is formed on a second substrate. The nitride light emitting diode and the thin film transistor are located between the first substrate and the second substrate and offset from each other. The touch unit includes a conductive connecting layer and a patterned wire. At least a part of the touch unit is formed between the first and second substrates.

### BACKGROUND

1. Technical Field

This disclosure generally relates to light emitting touch displays, and particularly to a light emitting touch display integrating a touch unit inside to make the light emitting touch display thinner.

2. Description of Related Art

A typical light emitting display includes a substrate, a plurality of light sources arranged on the substrate, and a light-guiding plate located at light path of the light sources. Conventionally, a touch screen is formed outside of the light-guiding plate to make the light emitting display have a touch function. However, because the touch screen is arranged at the outside of the light-guiding plate, the thickness of the entire light emitting touch display is increased.

What is needed, therefore, is a light emitting touch display with a touch function which can overcome the above-described shortcoming.

### BRIEF DESCRIPTION OF THE DRAWINGS

FIG. 1 is a cross-sectional view of a light emitting touch display according to a first embodiment of the present disclosure.

FIG. 2 is a cross-sectional view of a light emitting touch display according to a second embodiment of the present disclosure.

FIG. 3 is a cross-sectional view of a light emitting touch display according to a third embodiment of the present disclosure.

FIG. 4 is a cross-sectional view of a light emitting touch display according to a fourth embodiment of the present disclosure.

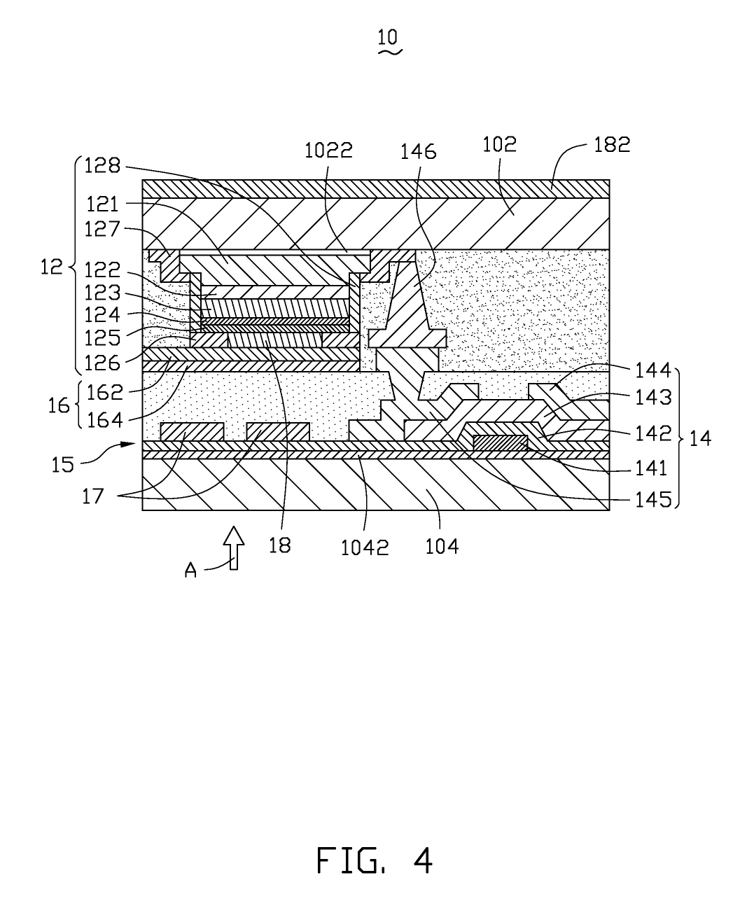

### DETAILED DESCRIPTION

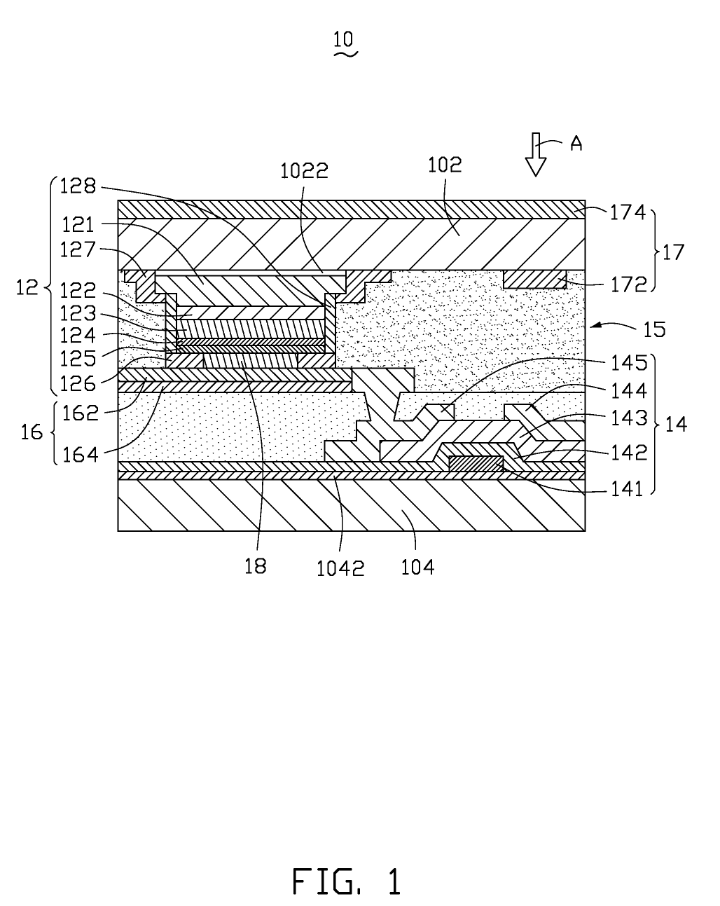

Referring to FIG. 1, a light emitting touch display 10 in accordance with a first embodiment of the present disclosure is provided.

The light emitting touch display 10 includes a nitride light emitting diode 12, a thin film transistor 14, and a touch unit 15. The nitride light emitting diode 12 is formed on a first substrate 102. The thin film transistor 14 is formed on a second substrate 104. The first substrate 102 is located above the second substrate 104, and is spaced from the second substrate 104. The first substrate 102 and the second substrate 104 are arranged face-to-face. The nitride light emitting diode 12 and the thin film transistor 14 are located between the first substrate 102 and the second substrate 104.

The touch unit 15 is formed on the first substrate 102. Alternatively, the touch unit 15 can be formed on the second substrate 104. The first substrate 102 and the second substrate 104 are made of sapphire, silicon, silicon on glass, glass, AlOₓ, GaN, ZnO, plastic or flexible plates. In this embodiment, the first substrate 102 is made of sapphire or silicon on glass, and the second substrate 104 is made of glass.

A first buffer layer 1022 is formed on the first substrate 102. The nitride light emitting diode 12 is formed on the first buffer layer 1022. A second buffer layer 1042 is formed on the second substrate 104. The thin film transistor 14 is formed on the second buffer layer 1042. The first buffer layer 1022 and the second buffer layer 1042 are electrically insulating layers and are electrically insulating from each other. The first buffer layer 1022 is made of AlGnInN, SiC, or ZnO, and the second buffer layer 1042 is made of SiOₓ, SiN_{X}, SiNO, HfOₓ, AlOₓ, TaOₓ, or BaSrTiOₓ. Preferably, the first buffer layer 1022 and the second buffer layer 1042 are low temperature GaN or SiOₓ.

The nitride light emitting diode 12 includes an n-type semiconductor layer 121, a light emitting layer 122, a p-type semiconductor layer 123, a contact layer 124 and a current spreading layer 125 sequentially formed on the first buffer layer 1022 along a top-to bottom direction. The light emitting layer 122 is a single quantum well or a multiple quantum well. The light emitting layer 122 is made of AlₓGayIn_{(1-x-y)}N, 0≦x≦1, 0≦y≦1.

The contact layer 124 is an ohmic contact layer. The current spreading layer 125 can be a doped inversion layer. The current spreading layer 125 is used to spread current into the p-type semiconductor layer 123 to increase the light efficiency of the nitride light emitting diode 12. A p-type electrode 126 is formed on the current spreading layer 125. An n-type electrode 127 is formed at a lateral side of the n-type semiconductor layer 121. An insulation layer 128 is formed between the n-type electrode 127 and the p-type electrode 126. The insulation layer 128 electrically insulates the n-type electrode 127 from the p-type electrode 126.

The nitride light emitting diode 12 emits UV light, blue light, green light or other visible light. Preferably, the wavelength of the light is ranged from 300 nm to 500 nm.

The thin film transistor 14 is located at a lateral side of the nitride light emitting diode 12 and includes a gate electrode 141, a source electrode 144 and a drain electrode 145. The gate electrode 141 is located between the source electrode 144 and the drain electrode 145, and is formed on the second buffer layer 1042. An insulation layer 142 is formed on the gate electrode 141 and covers the gate electrode 141. An active layer 143 is formed on the insulation layer 142. The source electrode 144 and the drain electrode 145 are formed on the active layer 143.

The insulation layer 142 is made of SiOx, SiNx, SiON, HfOx, AlOx, TaOx, BaSrTiOx, or a combination thereof. The active layer 143 is an active oxide semiconductor layer. The active layer 143 comprises at least a metal made of one of In, Ca, Al, Zn, Cd, Ca, Mo, Sn, Hf, Cu, Ti, Ba, and Zr. The active layer 143 is made of InGaZnO, InZnHfO, InZnZrO, InZnSnO, InZnO, AlInZnO, ZnO, AlInZnO or a combination thereof.

The source electrode 144 and the drain electrode 145 are selected from metal electrodes, oxide conductive electrodes, or a combination thereof

The touch unit 15 comprises a conductive connecting layer 16 and a patterned wire 17. A part of the patterned wire 17 and the conductive connecting layer 16 of the touch unit 15 are located between the first substrate 102 and the second substrate 104. The conductive connecting layer 16 electrically connects the nitride light emitting diode 12 and the thin film transistor 14. The conductive connecting layer 16 is selected from metal, conductive oxide, conductive glue, solder, carbon nanotube, graphene or a combination thereof.

The conductive connecting layer 16 can be a multilayer structure, which comprises a metal layer 162 and a transparent conductive oxide layer 164. The metal layer 162 is made of In, Ca, Al, Zn, Cr, Ni, Mo, Sn, Ag, Au, Cu, Ti, Bi, Co, or an alloy thereof. The transparent conductive oxide layer 164 is made of InSnO, ZnSnO, InZnO, AlZnO, InZnSnO, InGaZnO, InZnHfO, or InZnZrO. The conductive connecting layer 16 can also be made of silver glue, SnBi, SnBiCu, SnBiTe, SnBiSe, BiSbTe, BiTeSe, or SnAgCu. The conductive connecting layer 16 electrically connects the p-type electrode 126 of the nitride light emitting diode 12 and the drain electrode 145 of the thin film transistor 14.

The patterned wire 17 is made of metal, conductive oxide, carbon nanotube, graphene or a combination thereof. Alternatively, the patterned wire 17 is selected from InSnO, ITO, InZnO, IZO, AlSnO, ATO, AlZnO, AZO, InGaZnO, IGZO, or ZnO.

The patterned wire 17 includes a first patterned wire 172 and a second patterned wire 174. The first patterned wire 172 can be formed at an inner surface of the first substrate 102, or the first patterned wire 172 can be formed at an inner surface of the second substrate 104.

In this embodiment, the first patterned wire 172 is formed on the inner surface of the first substrate 102, and the second patterned wire 174 is formed on an outer surface of the first substrate 102. Such that, a touch operation can be performed by touching the outer surface of the first substrate 102.

In this embodiment, the nitride light emitting diode 12 is located on the inner surface of the first substrate 102. The thin film transistor 14 is located on an inner surface of the second substrate 104. Specifically, the nitride light emitting diode 12 is located at a left side of the first substrate 102, and the thin film transistor 14 is located at a right side of the second substrate 104. That is, the thin film transistor 14 deviates from a light path of the nitride light emitting diode 12, whereby a possibility of change of electrical characteristics of the active layer 143 of the thin film transistor 14 due to an illumination of the light from the nitride light emitting diode 12 thereon can be effectively reduced. The nitride light emitting diode 12 and the thin film transistor 14 are electrically connected via the conductive connecting layer 16. Specifically, the nitride light emitting diode 12 electrically connects with the thin film transistor 14 via an electrical connection between the p-type electrode 126 and the source electrode 144 or the drain electrode 145 of the thin film transistor 14.

The light emitting display 10 further comprises a phosphor layer 18. The phosphor layer 18 is located inside the light emitting display 10. Specifically, the phosphor layer 18 is located between the connecting layer 16 and the current spreading layer 125 and surrounded by the p-type electrode 126.

Alternatively, the phosphor layer 18 can be located outside the light emitting display 10; for example, the phosphor layer 18 may be located at an outer surface of the first substrate 102 or located at an outer surface of the second substrate 104.

The phosphor layer 18 absorbs a part of light emitted from the light emitting layer 122 of the nitride light emitting diode 12 and converts the part of light to another light with another wavelength, such as red light, green light, blue light, yellow light, or yellow-green light, which combines the remaining light from the light emitting layer 122 to obtain a resultant light radiating out of the nitride light emitting diode 12. The resultant light can be white light.

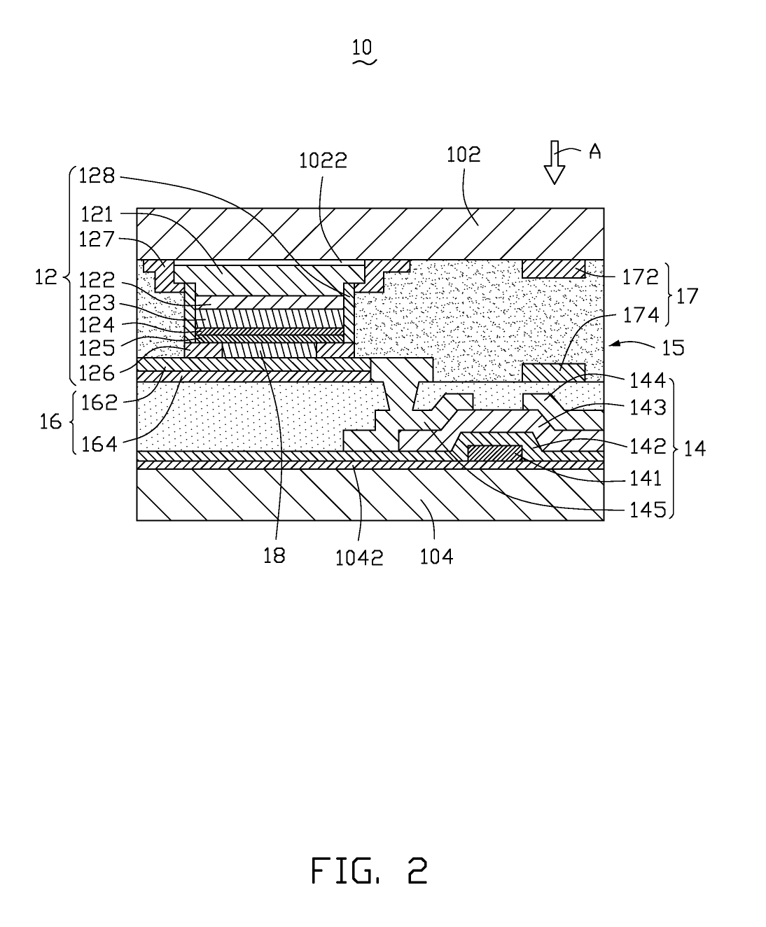

Referring to FIG. 2, in a second embodiment, the first patterned wire 172 is formed on the inner surface of the first substrate 102, and the second patterned wire 174 is formed on the thin film transistor 14 and located between the first and second substrates 102, 104, such that, a touch operation can be performed on the outer surface of the first substrate 102.

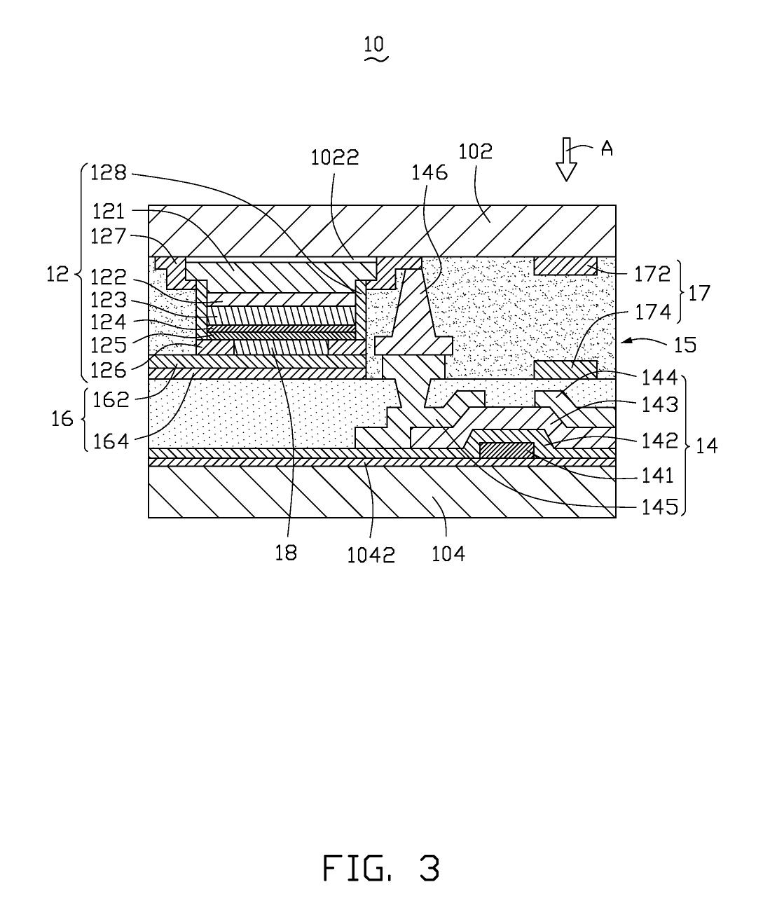

Referring to FIG. 3, in a third embodiment, a metal column 146 is formed on the drain electrode 145, and the metal column 146 electrically connects the drain electrode 145 to the n-type electrode 127 of the nitride light emitting diode 12, to make the nitride light emitting diode 12 electrically connect with the thin film transistor 14. In this embodiment, the metal column 146 is a part of the touch unit 15 and replaces the function of the conductive connecting layer 16, which in this embodiment is shortened so that it does not connect with the drain electrode 145 of the thin film transistor 14. The metal column 146 is located at a lateral side of the thin film transistor 14 and is adjacent to the nitride light emitting diode 12. Alternatively, the metal column 146 can be formed on the source electrode 144, whereby the nitride light emitting diode 12 can electrically connect with the thin film transistor 14 via the metal column 146 which electrically connects with the n-type electrode 127 of the nitride light emitting diode 12.

In addition, because the metal column 146 electrically connects the drain electrode 145 of the thin film transistor 14 with the n-type electrode 127 of the nitride light emitting diode 12, the metal column 146 also blocks the light emitted from the nitride light emitting diode 12 from radiating toward the active layer 143 of the thin film transistor 14, whereby an optical isolation between the nitride light emitting diode 12 and the active layer 143 can be further ensured.

In a fourth embodiment, the metal column 146 electrically connects the drain electrode 145 of the thin film transistor 14 with the n-type electrode 127 of the nitride light emitting diode 12. The touch unit 15 includes the patterned wire 17 and the conductive connecting layer 16. The patterned wire 17 is formed on the inner surface of the second substrate 104, such that a touch operation can be performed on the outer surface of the second substrate 104. In addition, the phosphor 18 is located inside the light emitting display 10. A reflecting layer 182 is formed on the outer surface of the first substrate 102 to reflect light emitted from the nitride light emitting diode 12 towards the second substrate 104.

According to the light emitting display of this disclosure, because the touch unit is located between the first substrate and the second substrate, that is, the touch unit is located inside the light emitting touch display 10 whereby the thickness of the light emitting touch display 10 is reduced, in comparison with the prior art.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A light emitting touch display, comprising:
a nitride light emitting diode;
a thin film transistor; and
a touch unit;
wherein the nitride light emitting diode is formed on a first substrate, the thin film transistor is formed on a second substrate, the first substrate and the second substrate are spaced from each other and are arranged face-to-face, the nitride light emitting diode and the thin film transistor are located between the first substrate and the second substrate, the touch unit comprises an electrically connecting means located between the first and second substrates and a patterned wire, the electrically connecting means of the touch unit electrically connects the nitride light emitting diode to the thin film transistor, and at least a part the patterned wire is formed on an inside of at least one of the first substrate and the second substrate.

2. The light emitting display of claim 1, wherein the first substrate and the second substrate are made of sapphire, silicon, silicon on glass, glass, GaN, ZnO, plastic or flexible plates.

3. The light emitting display of claim 2, wherein the first substrate is made of sapphire or silicon on glass, and the second substrate is made of glass.

4. The light emitting display of claim 1, wherein a first buffer layer is formed on an inner surface of the first substrate and the light emitting diode is formed on the first buffer layer.

5. The light emitting display of claim 4, wherein a second buffer layer is formed on an inner surface of the second substrate and the thin film transistor is formed on the second buffer layer.

6. The light emitting display of claim 5, wherein the first buffer layer and the second buffer layer are electrically insulating layers, and one of the first substrate and the second substrate is made of AlGaInN or SiOₓ.

7. The light emitting display of claim 1, wherein the nitride light emitting diode comprises an n-type semiconductor layer, a light emitting layer, a p-type semiconductor layer, a contact layer and a current spreading layer sequentially formed on the first substrate along a top to bottom direction, a p-type electrode is formed on the current spreading layer, an n-type electrode is formed at a lateral side of the n-type semiconductor layer.

8. The light emitting display of claim 7, wherein the light emitting layer is made of AlₓGayIn_{(1-x-y)}N, 0≦x≦1, 0≦y≦1.

9. The light emitting display of claim 7, wherein the light emitting diode emits light with wavelength of 300 nm-550 nm.

10. The light emitting display of claim 1, wherein the thin film transistor comprises a gate electrode, a source electrode and a drain electrode, the gate electrode is formed on the second substrate, an insulation layer is formed on the gate electrode and covers the gate electrode, an active layer is formed on the insulation layer, and the source electrode and the drain electrode are formed on the active layer.

11. The light emitting display of claim 10, wherein the insulation layer is made of SiOx, SiNx, SiON, HfOx, AlOx, TaOx, BaSrTiOx, or a combination thereof

12. The light emitting display of claim 10, wherein the active layer is an oxide semiconductor, and the active layer is made of InGaZnO, InZnHfO, InZnZrO, InZnSnO, InZnO, AlInZnO, ZnO, AlInZnO or a combination thereof.

13. The light emitting display of claim 12, wherein the active layer comprises at least a metal selected from one of In, Ca, Al, Zn, Cd, Ca, Mo, Sn, Hf, Cu, Ti, Ba, and Zr.

14. The light emitting display of claim 1, wherein the electrically connecting means is a metal column, the metal column is formed on a source electrode or a drain electrode of the thin film transistor, the metal column electrically connects with an n-type electrode of the nitride light emitting diode to electrically connect the thin film transistor with the nitride light emitting diode.

15. The light emitting display of claim 1, wherein the electrically connecting means is a conductive connecting layer electrically connecting a p-type electrode of the nitride light emitting diode and a drain electrode of the thin film transistor.

16. The light emitting display of claim 15, wherein the conductive connecting layer is a multilayer structure, and the multilayer structure comprises a metal layer and a transparent conductive oxide layer.

17. The light emitting display of claim 1, wherein the patterned wire comprises a first patterned wire and a second patterned wire, the first patterned wire is formed on an inner surface of the first substrate, the second patterned wire is formed on an outer surface of the first substrate.

18. The light emitting display of claim 1, wherein the patterned wire comprises a first patterned wire and a second patterned wire, the first patterned wire is formed on an inner surface of the first substrate, and the second patterned wire is formed on the thin film transistor.

19. The light emitting display of claim 1, wherein the patterned wire is located between the electrically connecting means and the second substrate.

20. The light emitting display of claim 1, wherein the patterned wire is made of metal, conductive oxides, carbon nano tube, grapheme or a combination thereof

21. The light emitting display of claim 1, wherein the patterned wire is made of InSnO, ITO, InZnO, IZO, AlSnO, ATO, AlZnO, AZO, InGaZnO, IGZO, or ZnO.

22. The light emitting display of claim 1, wherein the thin film transistor deviates from a light path of the nitride light emitting diode.

23. The light emitting display of claim 7, wherein a phosphor is located inside the nitride light emitting diode and is located between the electrically connecting means and the current spreading layer, and is surrounded by the p-type electrode.

24. The light emitting display of claim 23, wherein a reflecting layer is formed on an outer surface of the first substrate and the pattern wire is entirely located on an inner surface of the second substrate.
